(19) United States
(12) Patent Application Publication
(10) Pub. No.: US 2014/0351617 A1
(43) Pub. Date: Nov. 27, 2014

(54) Method and Electronic Device for Bringing a Primary Processor Out of Sleep Mode

(71) Applicant: Motorola Mobility LLC, Libertyville, IL (US)

(72) Inventors: Nathan M. Connell, Hawthorn Woods, IL (US); Christian L. Flowers, Chicago, IL (US); Michael E. Gunn, Barrington, IL (US)

(73) Assignee: Motorola Mobility LLC, Libertyville, IL (US)

(21) Appl. No.: 13/955,728

(22) Filed: Jul. 31, 2013

Related U.S. Application Data
(60) Provisional application No. 61/827,746, filed on May 27, 2013.

(51) Int. Cl. G06F 1/32

(52) U.S. Cl. CPC G06F 1/3265
USPC 713/323

(57) ABSTRACT

A method performed by an adjunct processor of a device for bringing a primary processor of the device out of a sleep mode includes monitoring a touchscreen of the device for a first continuous gesture. The method also includes sending, by the adjunct processor to the primary processor upon detecting the first continuous gesture, an initial awake command signal to awaken the primary processor from the sleep mode to initiate a primary processor awake sequence. Further, the method includes monitoring the touchscreen for completion of a second continuous gesture to initiate the sending, by the adjunct processor to the primary processor, of a primary awake command signal to indicate to the primary processor to complete the primary processor awake sequence.

### RELATED APPLICATIONS

The present application is related to and claims benefit under 35 U.S.C. §119(e) of U.S. Provisional Patent Application No. 61/827,746, filed May 27, 2013, titled “METHOD AND ELECTRONIC DEVICE FOR BRINGING A PRIMARY PROCESSOR OUT OF SLEEP MODE”, which is commonly owned with this application by Motorola Mobility LLC, and the entire contents of which is incorporated herein by reference.

### FIELD OF THE DISCLOSURE

The present disclosure relates generally to processor latency in an electronic device, and more particularly to a method and electronic device for bringing a primary processor of the device out of sleep mode while concealing processor latency.

### BACKGROUND

When a user is not actively using an electronic device, the device can timeout and move into a sleep mode. After the device is in the sleep mode, the user can take an explicit action that is directed at the device to cause the device to exit the sleep mode and to move into an active mode. When the device is in the active mode, the device can further respond to user input to perform requested functionality such as making a call or executing one or more applications such as text messaging or email. The time it takes for the device to move from the sleep mode to the active mode is a latency time that is noticeable to a user. Moreover, when a user perceives the latency associated with bringing the device out of the sleep mode, the user may associate the device with being a slow responding device or a problematic device. Accordingly, addressing this perceivable latency is desirable.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of some of those embodiments.

FIG. 1 illustrates a diagram of an electronic device in which embodiments of the present disclosure can be implemented for bringing a primary processor out of a sleep mode.

FIG. 2 is a flowchart illustrating a method performed by an adjunct processor for bringing a primary processor out of sleep mode in accordance with an embodiment of the present disclosure.

FIG. 3 illustrates example configurations of touchscreens in accordance with embodiments of the present disclosure.

FIG. 4 illustrates example continuous gestures performed on a touchscreen of a device in accordance with an embodiment of the present disclosure.

FIG. 5 is a flowchart illustrating a method performed by a primary processor for exiting from a sleep mode in accordance with an embodiment of the present disclosure.

FIG. 6 is a flowchart illustrating a method performed by a primary processor for exiting from a sleep mode in accordance with an embodiment of the present disclosure.

### DETAILED DESCRIPTION

Generally speaking, pursuant to the various embodiments, an adjunct processor of an electronic device performs a method for bringing a primary processor of the electronic device (also referred to herein simply as a “device”) out of a sleep mode. The adjunct processor monitors inputs from a touchscreen to determine whether a continuous gesture indicates that a user is likely to bring the device out of a sleep mode and into an active mode, which is also referred to herein as a full awake mode. Upon detecting a first continuous gesture, which indicates that the user is likely to bring the device out of the sleep mode, the adjunct processor sends an initial awake command signal to a primary processor, which initiates a primary processor awake sequence. Upon detecting a second continuous gesture, which represents an explicit request, command, or instruction to operate the device, the adjunct processor sends the primary processor a primary awake command signal, which causes the primary processor to complete the primary processor awake sequence and enter into the full awake or active mode. In one embodiment, a single continuous gesture includes both the first continuous gesture and the second continuous gesture.

In one example embodiment, a method is performed by an adjunct processor of a device for bringing a primary processor of the device out of a sleep mode. The method includes monitoring a touchscreen of the device for a first continuous gesture. The method also includes sending, by the adjunct processor to the primary processor upon detecting the first continuous gesture, an initial awake command signal to awaken the primary processor from the sleep mode to initiate a primary processor awake sequence. Still further, the method includes, monitoring the touchscreen for completion of a second continuous gesture to initiate the sending, by the adjunct processor to the primary processor, of a primary awake command signal to indicate to the primary processor to complete the primary processor awake sequence.

In another embodiment, an electronic device includes a touchscreen and a primary processor configured to receive at least one of a primary awake command signal or an initial awake command signal and to responsively awaken from a sleep mode and initiate a primary processor awake sequence. The electronic device also includes an adjunct processor coupled to the touchscreen and the primary processor and configured to: monitor the touchscreen for a first continuous gesture and send the initial awake command signal to the primary processor upon detecting the first continuous gesture; and monitor the touchscreen for completion of a second continuous gesture to initiate the sending of the primary awake command signal to indicate to the primary processor to complete the primary processor awake sequence.

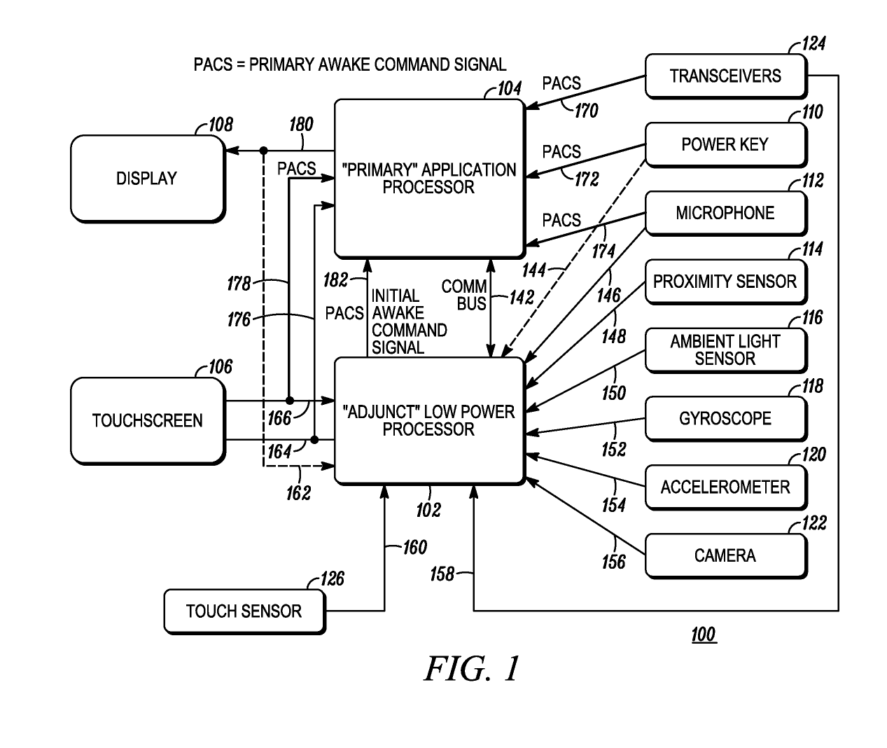

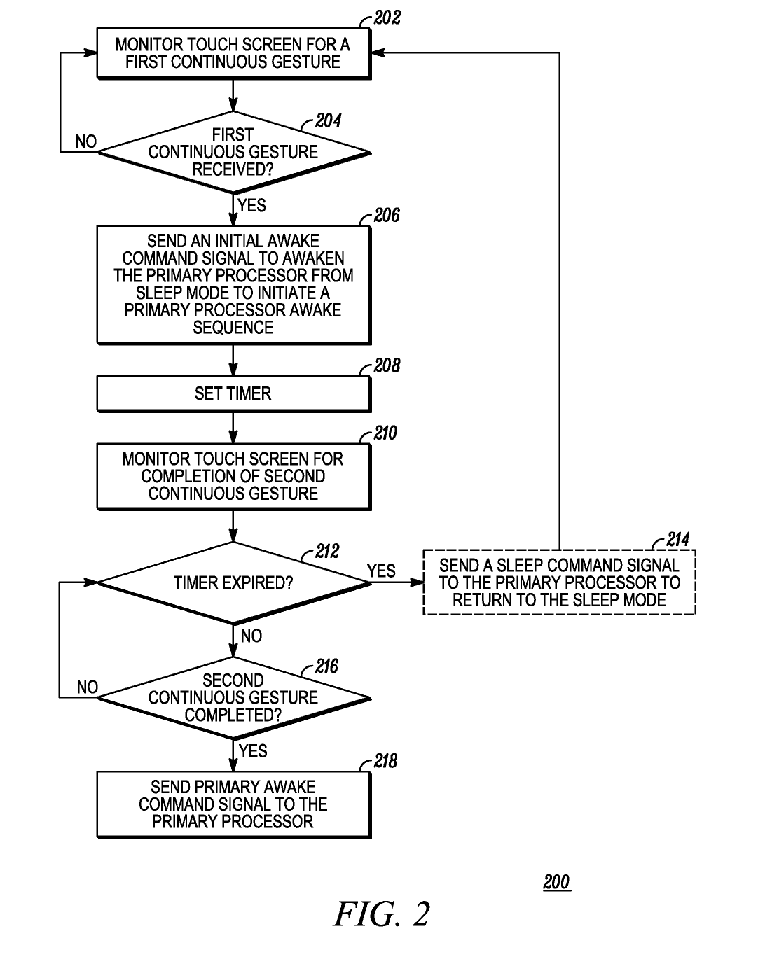

Referring now to the drawings, FIG. 1 illustrates an embodiment of an electronic device 100 for bringing a primary processor out of sleep mode in accordance with an embodiment of the present disclosure. The electronic device 100 includes an adjunct processor 102 and a primary processor 104 configured to perform methods in accordance with the present teachings, for instance methods illustrated by reference to the remaining FIGS. 2-6. The electronic device 100 further includes other device components of: a touchscreen 106, a display 108, a power key 110, a microphone 112, a proximity sensor 114, an ambient light sensor 116, a gyroscope 118, an accelerometer 120, a camera 122, transceivers 124 including a cellular transceiver and at least one transceiver configured to connect to a peripheral device, and a touch sensor 126 such as a perimeter touch sensor. “Adapted,” “operative,” “capable” or “configured,” as used herein, means that the indicated elements or components are implemented using one or more hardware devices such as one or more operatively coupled processing cores, memory devices, and interfaces, which may or may not be programmed with software and/or firmware as the means for the indicated elements to implement their desired functionality. Such functionality of the adjunct processor 102 and the primary processor 104 is supported by the other hardware shown in FIG. 1.

Moreover, other components of the electronic device 100 are not shown in an effort to focus on the disclosed embodiments and to keep the detailed description to a practical length. Such other components include, but are not limited to, additional processors and memory components, transceivers such as a Global Positioning System (GPS) transceiver, additional Input/Output (I/O) devices such as a mechanical keyboard and speakers, etc. Additionally, electronic device 100 may be implemented as any number of different types of electronic devices. These electronic devices include, by way of example, a laptop, a smartphone, a personal data assistant (PDA), a digital media player, a portable or mobile phone, a cellular phone, a personal wearable device, a tablet, a notebook computer such as a netbook, an eReader, or any other device having a primary processor and an adjunct processor, wherein the adjunct processor can be used to provide an early wakeup signal to the primary processor in accordance with the present teachings.

The display 108 is an optical display such as a liquid crystal display (LCD) that translates electrical signals representing a given image, which it receives over a link 180, to optical signals by which the image can be seen through optical effects. For example, each pixel of the image corresponds to a capacitor that is charged and slowly discharged to display the image on the display 108. The display 108 is coupled to the primary processor 104 using the link 180 and, in one particular and optional embodiment, may also be coupled to the adjunct processor 102 using a link 162, e.g., a hardware coupling. Using this topology, the display 108 is configured to receive a display awake command signal, from the primary processor 104 using the link 180 or the adjunct processor 102 using the link 162, to responsively initiate a display awake sequence. The display awake sequence is used to awaken the display 108 from a sleep mode to an active mode such that it is ready to display images thereon.

The touchscreen 106 provides a means for receiving tactile (or touch) input resulting from a user's finger or some other input device such as a stylus, glove, fingernail, etc., contacting the touchscreen 106. The contact with the touchscreen 106 and the resulting touch input is characterized by at least one of a motion, an input sequence, or a pattern on and/or directed at the touch screen. A contact with the touchscreen 106 includes a physical and/or a proximal interaction with the touchscreen 106 (depending on the type of touchscreen technology implemented), which is sensed by sensing hardware, also referred to herein as sensor elements, included within the touchscreen 106. One example of a continuous contact on the touchscreen is characterized by a contact that is maintained on a same sensor element or set of sensor elements until a time threshold is met. Another example of a continuous contact is characterized by an unbroken motion, input sequence, and/or pattern across a series or sequence of sensor elements.

As used herein, a gesture is a predetermined motion, input sequence, and/or pattern on or directed at the touchscreen 106, wherein the resulting tactile input is recognizable or detectable, by a processor such as the adjunct processor 102 and/or the primary processor 104, as being the predefined gesture. A continuous gesture is defined by a continuous contact with the touchscreen 106 that meets or satisfies a predefined criterion. The criterion can be defined by any one or combination of parameters including, but not limited to: crossing a line or boundary of sensor elements or into an area of sensor elements on the touchscreen 106; satisfying a distance threshold, for instance along one or more axes or paths on the touchscreen 106; satisfying a time threshold, for instance for a contact within a predefined area of sensor elements on the touchscreen 106, etc.

In one embodiment, a continuous gesture is considered as completed upon the predefined criterion being satisfied, even while the contact continues. For example, a first continuous gesture that causes the adjunct processor to send an initial awake command signal to the primary processor may be considered as complete once the motion crosses over, into, or within a boundary of sensor elements. In another embodiment, the continuous gesture is considered as completed only when the contact with the touchscreen 106 is broken or discontinued after the predefined criterion is satisfied.

Moreover, although continuous gestures may be referred to herein separately, as is the case with referenced first and second continuous gestures, multiple continuous gestures may be included within a single continuous gesture and/or a single continuous gesture may be inclusive of one or more other continuous gestures. For example, a second continuous gesture may contain or include a first continuous gesture. In such a case, contact with the touchscreen 106 is maintained until the criterion for the first continuous gesture is satisfied. This same contact then continues unbroken until the criterion for the second continuous gesture is satisfied, as will be described later in further detail. Alternatively, separately mentioned gestures, such as the first and second continuous gestures, may be completely separate contacts on the touchscreen 106.

In a particular embodiment, the touchscreen 106 can operate in accordance with any suitable technology for sensing touch such as, by way of example, resistive, surface acoustic wave, capacitive, infrared grid, acoustic pulse, etc. Accordingly, the touchscreen 106 contains a plurality of sensor elements arranged to form, for instance, a two dimensional grid along an x-axis and a y-axis to enable a processor to determine x and y coordinates corresponding to sensed contact. The type of sensor elements implemented depends on the type of touchscreen technology employed. For example, the plurality of sensor elements could correspond to a plurality of discreet components on a two-dimensional touchscreen panel such as a plurality of capacitors implemented within one touchscreen embodiment that uses a mutual capacitance Projected Capacitive Touch (PCT) approach. For other capacitive technologies, the touchscreen comprises a two-dimensional panel composed of an insulator that is coated with a transparent conductor layer. For some resistive technologies, the two-dimensional touchscreen panel is formed using multiple transparent electrically-resistive layers separated by a thin space. Thus, each “sensor element” in the later two cases is effectively defined by an x, y coordinate location on the two-dimensional touchscreen panel.

The touchscreen 106 is coupled to the adjunct processor 102 using links 166 and 164 and to the primary processor 104 using links 178 and 176. In an embodiment, links 178 and 166 are communication interfaces such as communication busses for communicating data. Such data can indicate receipt of touch input on the touchscreen 106. In a further embodiment, links 176 and 164 are wire connections such as one or more pins used to communicate a signal such as an interrupt signal used to alert the processors 102 and 104 that touch has been sensed on the touchscreen 106. Although shown as separate components, the display 108 and touchscreen 106, in an alternative arrangement, are integrated into a single component.

The primary processor 104 provides main or core processing capabilities within the electronic device 100 and, in an embodiment, serves as an application processor. For example, the primary processor 104 is implemented as a system-on-chip (SoC) that supports word processing applications, email and text messaging applications, video and other image-related and/or multimedia applications, etc., executable on the electronic device 100. The adjunct processor 102 is a separate processor that, in an embodiment, handles peripheral or supportive processes for the primary processor 104. In a particular embodiment, the adjunct processor 102 supports processes that require less processing power than those performed by the primary processor 104 and is, thereby, also referred to herein as a lower or “low” power processor. For example, the adjunct processor 102 monitors tactile input onto the touchscreen 106 in order to perform its functionality according to the present teachings.

The adjunct processor 102 and the primary processor 104 are configured to be coupled to each other over links 142 and 182. In an embodiment, link 142 is a communication bus interface that supports one or more standard or proprietary protocols for communicating data, control, and/or clock signals between the processors 102 and 104. In a particular embodiment, interface 142 is a bidirectional Mobile Industry Processor Interface (MIPI). MIPIs support numerous protocols including, but not limited to M-PHY, D-PHY, Display Serial Interface (DSI), MIPI Unified Protocol (UniPro), Low Latency Interface (LLI), SuperSpeed Inter-chip (SSIC), Camera Serial Interface (CSI), to name a few. As used herein, a MIPI is a chip-to-chip interface that conforms to standards created by the MIPI Alliance Standards Body, which standardizes interfaces for mobile applications.

In an embodiment, link 182 includes one or more wire connections, such as one or more pins, over which signals are sent. For example, one pin provides, supplies or sends an initial awake command signal, in accordance with the teachings herein, from the adjunct processor 102 to the primary processor 104 when the pin goes high (or, alternatively, low depending on the particular embodiment). In another embodiment, link 182 includes another pin that provides a primary awake command (PACS) signal from the adjunct processor 102 to the primary processor 104 when the pin goes high (or, alternatively, low).

A primary awake command signal is a signal provided to initiate a primary processor awake sequence to transition or awaken the primary processor 104 from a sleep mode in order to operate in an active or full awake mode, upon completion of the primary processor awake sequence, to support its normal functionality. The primary awake command signal is sent in response to, and is thereby associated with, an explicit request, command, or instruction to operate the electronic device 100. Such a request results from certain events such as those described below including, but not limited to, certain gestures on and/or directed at the touchscreen 106.

In one embodiment, a component providing the primary awake command signal is referred to herein as an “awakening component.” Accordingly, in the embodiment shown, the following example components can serve as the awakening component to directly provide the primary awake command signal to the primary processor 104 over a link in response to the following associated events: the cellular transceiver 124 over a link 170, for instance in response to receiving a call; the power key 110 over a link 172 in response to a user depressing the power key 110; the microphone 112 over a link 174 in response to receiving a voice command; and the touchscreen 106 over the link 178 in response to receiving tactile (or touch) input, e.g., the entering of an alphanumeric passcode and/or a swipe sequence or gesture, etc. As such, the primary awake command signal is provided in response to at least one of a depressed power key, an audio awake command, an incoming call, or an input sequence on the touchscreen 106.

In another embodiment, the adjunct processor 102 is coupled to the touchscreen 106 over the link 166, to the power key 110 over a link 144, to the microphone 112 over a link 146, and to the cellular transceiver 124 over a link 158 to receive indication of the aforementioned events. Correspondingly, the adjunct processor 102 is configured to responsively provide the primary awake command signal to the primary processor 104 over the link 182.

In accordance with at least some implementation scenarios, in essence the initial awake command signal provides an “early” awake command signal to the primary processor 104, wherein early means that the initial awake command signal is sent prior to the primary processor 104 receiving the primary awake command signal. This early awakening of the primary processor 104 before an explicit request to operate the electronic device 100 serves to conceal from a user of the device 100 at least a portion or at least some of the latency associated with the primary processor awake sequence.

The device components that provide the inputs to the adjunct processor 102 for determining whether to awaken the primary processor 104 using the initial awake command signal include, but are not necessarily limited to, one or more of: the touchscreen 106, the accelerometer 120, the proximity sensor 114, the ambient light sensor 116, the gyroscope 118, the microphone 112, the touch sensor 126, a transceiver 124 configured to connect to a peripheral device such as a headset or speaker, or the camera 122, each coupled to the adjunct processor 102. For example, each of the components 110-126 is configured to provide over a link one or more inputs that can indicate the likelihood of the providing of the primary awake command signal.

Particularly, the transceiver 124 is coupled to and configured to provide inputs to the adjunct processor 102 using the link 158. The microphone 112 is coupled to and configured to provide inputs to the adjunct processor 102 using the link 146. The proximity sensor 114 is coupled to and configured to provide inputs to the adjunct processor 102 using a link 148. The ambient light sensor 116 is coupled to and configured to provide inputs to the adjunct processor 102 using a link 150. The gyroscope 118 is coupled to and configured to provide inputs to the adjunct processor 102 using a link 152. The accelerometer 120 is coupled to and configured to provide inputs to the adjunct processor 102 using a link 154. The camera 122 is coupled to and configured to provide inputs to the adjunct processor 102 using a link 156. The touch sensor 126 is coupled to and configured to provide inputs to the adjunct processor 102 using a link 160. The touchscreen 106 provides indications of tactile input sequences, gestures, and/or patterns to the adjunct processor 102 using the link 166.

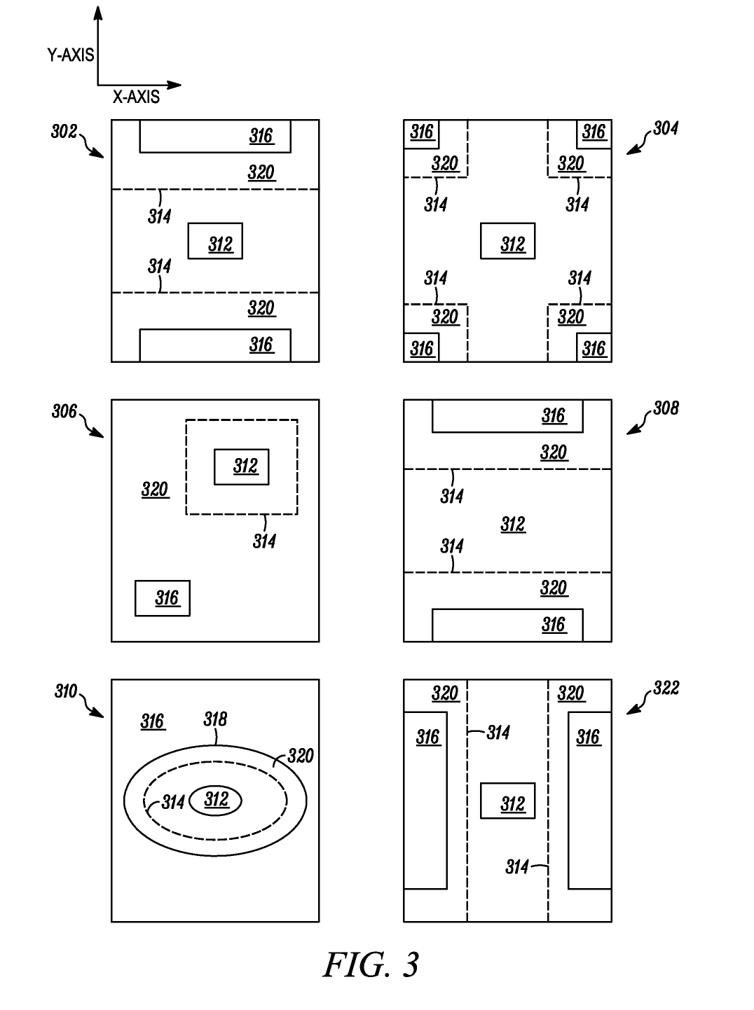

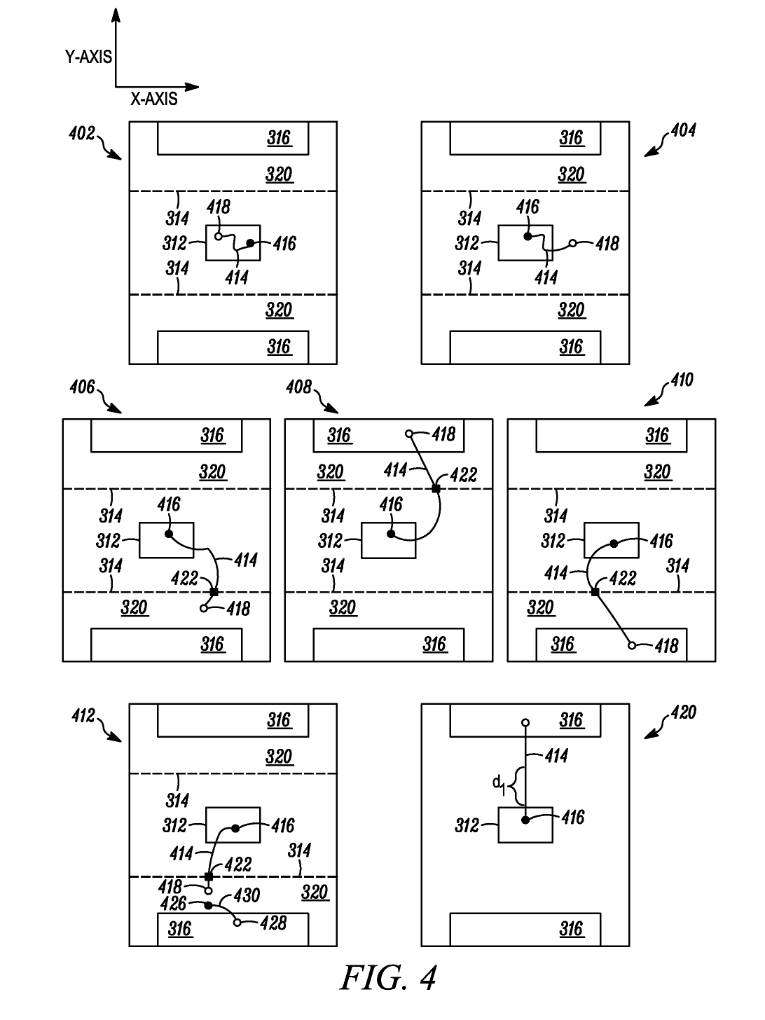

The present disclosure focuses on the touchscreen 106 providing inputs to the adjunct processor 102 for determining whether to awaken the primary processor 104 using the initial awake command signal, embodiments of which are described by reference to the remaining figures. Particularly, FIGS. 2-4 are used to describe a method 200 of FIG. 2 that is performed by an adjunct processor, such as processor 102, for bringing a primary processor, such as primary processor 104, out of a sleep mode, in accordance with various embodiments of the present disclosure. FIG. 3 shows touchscreen 106 embodiments having regions delineated thereon for detecting gestures used to determine when to awaken the primary processor in accordance with the present teachings. FIG. 4 illustrates a plurality of different contacts and gestures performed on a touchscreen, such as touchscreen 106, some of which satisfy criteria for awakening the primary processor in accordance with the present teachings. In describing the method 200 of FIG. 2, an embodiment 302 of a touchscreen shown in FIG. 3 is referenced as well as examples 402-412 of contacts and gestures shown in FIG. 4.

Turning now to the method 200 shown in FIG. 2, the adjunct processor continuously monitors 202 the touchscreen to detect 204 a first continuous gesture. In an embodiment, the adjunct processor monitors tactile inputs that correspond to contact to the touchscreen. The adjunct processor translates these tactile inputs into one or more x, y coordinates on the touchscreen panel or otherwise identifies the location of the contact to the touchscreen to determine whether a gesture on and/or directed at the touchscreen satisfies a particular criterion for detection as the first continuous gesture.

In embodiments illustrated by reference FIG. 3, the touchscreen comprises a plurality of sensor elements for indicating contact to the touchscreen. An initial region or area 312 of the touchscreen is delineated by a first set of one or more of the plurality of sensor elements. A first region 320 of the touch screen is delineated by a second set of the plurality of sensor elements, and a second region 316 is delineated by a third set of the plurality of sensor elements. The second region is also referred to herein as a full awake region because appropriate contact in this region (e.g., upon completion of a particular gesture) initiates an awakening of the primary process to the active or full awake mode. In some example implementations, a graphical user interface shows visible lines on the touchscreen 106 that delineate the initial 312, first, and second 316 regions. Alternatively, such lines are hidden from the user.

In a further example implementation, the sensor elements that are contained within the initial 312, first, and second 316 regions of the touchscreen are mutually exclusive. Thus, none of the initial 312, first, or second 316 regions share any sensor elements in common within the respective regions but may share one or more common sensor elements at boundaries between the regions. Moreover, the sensor elements that make up the initial 312, first, and second 316 regions can be represented by discreet sensor elements or x, y coordinate locations, as described above. In addition, the adjunct processor can include a mapping of regions, lines (e.g., confidence lines 314) that are mapped to coordinates, e.g., x, y, pixel coordinates on the touchscreen to determine in what “region” or “area” of the touchscreen a touch occurs.

In the FIG. 3 embodiment, the criteria used to detect 204 the first continuous gesture is defined by crossing a line or boundary 314 of sensor elements on the touchscreen. This boundary or line 314 of sensor elements is also referred to herein as a “confidence line.” The confidence line 314 sets a boundary for the second plurality of sensor elements that make up the first region. 320

In general, with respect to the touchscreen embodiments shown in FIG. 3, detecting 204 the first continuous gesture includes detecting a continuous contact that begins outside of the first region 320 of the touchscreen and crosses over the confidence line 314 into the first region 320 of the touchscreen. In addition, with respect to the touchscreen embodiments shown in FIG. 3, detecting 204 the first continuous gesture includes detecting that the continuous contact begins in the initial region 312 on the touchscreen and crosses over the confidence line 314 into the first region 320 of the touchscreen. Thus, for these embodiments, the adjunct processor is configured to detect 204 the first continuous gesture by detecting contact to the touchscreen across multiple sensor elements beginning at a first sensor element in the initial region 312 and continuing to a second sensor element in the first region 320.

More specifically with respect to the touchscreen shown at 302 of FIG. 3, the touchscreen is shown as a two-dimensional panel positioned in a vertical upright position. In this vertical position, the plurality of sensor elements of the panel are thus arranged within a two-dimensional grid along an x-axis and a y-axis, as shown, to sense contact to the touchscreen, wherein the contact is indicated to the adjunct processor as tactile input. The initial region 312 of the touchscreen shown at 302 includes a set of one or more sensor elements located in a central region of touchscreen. Moreover, the first region 320 is delineated by at least one confidence line 314 of sensor elements that extends from a first side of the touchscreen to a second side of the touchscreen along an x-axis of the touchscreen.

The embodiment shown at 302 includes two confidence lines 314 that delineate the first region 320. One confidence line 314 is located within the upper half of the touchscreen, and the other confidence line 314 is located within the lower half of the touchscreen. Also, the confidence lines 314 are shown as extending the entire width of the panel. However, in an alternative embodiment, the confidence lines 314 extend only substantially the width of the panel and exclude, for instance, pixels on the touchscreen that make up a horizontal front and back porch.

Accordingly, in the touchscreen embodiment shown at 302, detecting 204 the first continuous gesture includes detecting a continuous contact that begins in the central initial region 312 on the touchscreen and crosses into the first region 320 of the touchscreen. The contacts shown on the touchscreens at 402, 404, and 406 of FIG. 4 can be used to illustrate the adjunct processor monitoring 202 for the first continuous gesture. For each of the views shown in FIG. 4, a solid dot 416 indicates a location where an instrument, such as a user finger, stylus, fingernail, glove, or some other item, initially or first contacts the touchscreen. A solid line 414 indicates a path created by a continuous contact of the instrument over multiple sensor elements of the touchscreen. Further, an open circle 418 indicates a location of where the instrument discontinues contact with the touchscreen.

As illustrated by reference to the touchscreen view shown at 402, the contact begins 416, forms a path 414 and ends 418 all within the initial region 312. Accordingly, this is one example where contact with the touchscreen results in the adjunct processor 102 failing to detect 204 the first continuous gesture. Likewise, the view shown at 404 provides another example where contact with the touchscreen results in the adjunct processor 102 failing to detect 204 the first continuous gesture. With further respect to 404, the contact starts 416 in the initial region 312 and continues to create a path 414 outside of the initial region 312. However, the path 414 fails to cross the confidence line 314 and, thus, discontinues outside the first region 320.

Conversely a contact shown at 406 illustrates one example of where the adjunct processor actually detects 204 the first continuous gesture. In this case, the contact starts 416 in the initial region 312 and forms a path 414. The path 414 continues outside the initial region 312, crosses the bottom confidence line 314 at 422, and ends 418 in the first region 320. In this embodiment, upon crossing 422 the confidence line 314, the adjunct processor detects 204 the continuous contact 414 as being the predefined first continuous gesture.

Upon detecting 204 the first continuous gesture, the adjunct processor sends 206 an initial awake command signal to awaken the primary processor from sleep mode to initiate a primary processor awake sequence. In this embodiment, the adjunct processor sets 208 a timer and begins monitoring 210 the touchscreen until it detects 216 completion of a second continuous gesture or until detecting 212 that the timer set at 208 has expired. The timer thereby provides a time threshold for monitoring for an explicit request to fully awaken the primary processor, which if not met would allow to primary processor to return to the sleep mode to conserve power.

Upon detecting the completion of the second continuous gesture, the adjunct processor sends 218 a primary awake command signal to the primary processor to indicate to the primary processor to complete the primary processor awake sequence. By contrast, where the timer expires before the adjunct processor detects 216 the completion of the second continuous gesture, the adjunct processor returns to monitoring 202 the touchscreen for the first continuous gesture. In one optional embodiment upon failing to detect the completion of the second continuous gesture and prior to returning to monitoring for the first continuous gesture, the adjunct processor sends 214 a sleep command signal to the primary processor to control the return of the primary processor to the sleep mode.

As with the first continuous gesture, the adjunct processor monitors tactile inputs that correspond to contact to the touchscreen. The adjunct processor translates these tactile inputs into one or more x, y coordinates on the touchscreen panel or otherwise identifies the location of the contact to the touchscreen to determine whether a gesture on and/or directed at the touchscreen satisfies a particular criterion for detection as the completed second continuous gesture. For example, detecting 216 the completion of the second gesture includes detecting a contact with the touchscreen that starts in an initial region of the touchscreen such as the region 312 shown at 302 of FIG. 3 and discontinues in a final region of the touchscreen such as one of the second regions 316 also shown at 302 of FIG. 3. Accordingly, failing to detect the completion of the second continuous gesture comprises detecting that the contact with the touchscreen discontinues outside of the final, e.g. second, region. Turning again to the contact shown at 406, because the continuous contact 414, discontinues 418 outside of the second (final) region 316, the adjunct processor fails to detect the completion of the second continuous gesture in this case.

Returning again to the performing of the method 200, in accordance with an embodiment the adjunct processor is configured to detect completion of the second continuous gesture by detecting contact to the touchscreen across multiple sensor elements beginning at a first sensor element in the initial region 312 and ending with a second sensor element in the second region 316. The adjunct processor is further configured to: send 218 the primary awake command signal to the primary processor upon detecting 216 the contact ending within the second region 316; or send 214 the sleep command signal to the primary processor to return the primary processor to the sleep mode upon detecting the contact ending outside of the second region.

As described above, with respect to 406, the adjunct processor may send 214 the sleep command signal to the primary processor upon detecting that the contact 414 ended outside of the second region 316. However, continuous contacts shown at 408 and 410 of FIG. 4 provide examples of where the adjunct processor detects 216 the completion of the second continuous gesture and sends 218 the primary awake command signal to the primary processor. Turning to the contact shown at 408. The contact starts 416 in the initial region 312, continues along a path 414 across 422 the top confidence line 314 in the upper half of the touchscreen, causing the adjunct processor to detect 204 the first continuous gesture and send 206 the initial awake command signal. The path 414 then continues unbroken into the second region 316 toward the top of the touchscreen and discontinues in this region. In an embodiment, the adjunct processor detects the completion of the second continuous gesture as soon as the path 414 crosses into the second region 316. Alternatively, the adjunct processor detects the completion of the second continuous gesture when the continuous contact 414 is discontinued in the second region 316 of the touchscreen.

Similarly, with respect to the contact shown at 410, the contact starts 416 in the initial region 312, continues along a path 414 across 422 the bottom confidence line 314 in the lower half of the touchscreen. This causes the adjunct processor to detect 204 the first continuous gesture and send 206 the initial awake command signal. The path 414 then continues unbroken into the second region 316 toward the bottom of the touchscreen and discontinues in this region. This causes the adjunct processor to detect 216 the completion of the second continuous gesture and send 218 the primary awake command signal to the primary processor. In a particularly embodiment, the second full awake region 316 at the top of the touchscreen causes the primary processor, in response to the primary awake command signal, to complete the primary processor awake sequence and to perform a given function, such as opening an email application. Whereas, the second full awake region 316 at the bottom of the touchscreen causes the primary processor, in response to the primary awake command signal, to complete the primary processor awake sequence and to perform a different function, such as opening a social networking application.

In both examples 408 and 410, the entire path 414 from start 416 continuing on through completion 418 corresponds to a single continuous gesture, which in this case is detected as the second continuous gesture. However, the second continuous gesture is also inclusive of the first continuous gesture, which is detected, as stated above, once the path 414 crosses the confidence line 314. Accordingly, detecting the completion of the second continuous gesture includes detecting that the contact is maintained from the first region 320 into the second region 316 of the touchscreen. In such cases, it can also be said that since the first continuous gesture lies along the path 414 of the second continuous gesture, the first continuous gesture indicates a likelihood of receiving the second continuous gesture onto the touchscreen. Therefore, the adjunct processor is configured in accordance with the present teachings to send 206 the initial awake command signal in anticipation of detecting the completion of the gesture in the second region 316.

In a further embodiment, the first and second continuous gestures are not contained within a single gesture but are separate gestures. Take the example shown at 412 of FIG. 4. A contact starts 416 in the initial region 312 and continues as a path 414 across 422 the confidence line 314 into the first region 320, which corresponds to the adjunct processor detecting to the first continuous gesture. The path 414 discontinues 418 outside the second or full awake region 316. However, the user reestablishes 426 contact within the first region 320, and creates a path 430 that discontinues 428 within the full awake region, and the adjunct processor responsively sends to primary awake command signal. In an embodiment, if the contact is reestablished 426 within a time threshold, the adjunct processor detects the path 414 as the second continuous gesture if preceded by detecting the first continuous gesture.

Yet another embodiment is illustrated at 420 in FIG. 4. In this embodiment, detecting the first continuous gesture includes detecting a continuous contact along the touchscreen that extends a distance that exceeds a distance threshold. Further, the distance is along a path traveled for the completion of the second continuous gesture. As shown, the adjunct processor detects completion of the second gesture upon detecting a continuous contact 414 that begins in the initial region 312 and ends 418 in the second region 316. In this embodiment, the continuous contact 414 also includes the first continuous gesture, which is detected when the distance traveled along the path 414 exceeds a distance threshold d₁. Any suitable algorithm can be used for translating pixel or coordinate locations into distance.

We now return to FIG. 3 to describe the remaining example views 304-322. Views 304-322 illustrate additional embodiments for delineating initial 312, first 320, and second (full awake) 316 regions on a touchscreen. Regions 312, 320, and 316 enable the adjunct processor to detect the first and second continuous gestures at 204 and 216, respectively, of method 200 of FIG. 2 and to, thereby, send the appropriate signaling to awaken the primary processor.

Turning first to the view 304, the initial region 312 has a substantially square shape and is disposed substantially in the center of the touchscreen, similar to the initial region 312 shown in FIG. 3. There is a full awake region 316 disposed in each of the four corners of the touchscreen, and a confidence line 314 indicated with dashed lines surrounds each full awake region 316 to set the boundaries for the first region 320.

In the view 306, the initial region 312 has a substantially square shape and is disposed in an upper right quadrant of the touchscreen. However, in other example implementations the initial region 312 is disposed in one or more of the other three quadrants of the touchscreen. Further, the confidence line 314 surrounds the initial region 312, to set the boundaries for the first region 320, and has a substantially same shape as the initial region 312. The full awake region 316 is located in a quadrant, in this case a lower left quadrant, opposite that of the initial 312 and first regions 320.

In the view 308, the touchscreen includes confidence lines 314 that determine the first regions 320 and full awake regions 316 in both the upper and lower halves of the touchscreen. The initial region 312 in this embodiment 308 includes the entire area of the touchscreen 106 between the two confidence lines 314.

In the view 310, the initial region 312 is a substantially circular area delineated on the touchscreen. The area of the touchscreen outside a circle 318 is the full awake region 316. Further, the confidence line 314 surrounds the initial region 312 and has a substantially same shape as the initial region 312. The confidence line 314 sets the boundaries for the first region 320 to the area between the confidence line 314 and the line 318 delineating the second region. As can be seen in views 306 and 310, the first region 320 is delineated by a set of sensor elements arranged in a geometric shape around the initial region 312 within which a contact begins.

The view 322 is similar to the view 302. More specifically, the touchscreen is shown as a two-dimensional panel positioned in a vertical upright position. In this vertical position, the plurality of sensor elements of the panel are thus arranged within a two-dimensional grid along an x-axis and a y-axis, as shown, to sense contact to the touchscreen, wherein the contact is indicated to the adjunct processor as tactile input. The initial region 312 of the touchscreen shown at 322 includes a set of one or more sensor elements located in a central region of touchscreen. Moreover, the first region 320 is delineated by at least one confidence line 314 of sensor elements that extends from a first side of the touchscreen to a second side of the touchscreen along the y-axis of the touchscreen and may or may not include horizontal front and back porches. The full awake regions 316 are located on the left and right sides of the panel and are exclusive of the first regions 320.

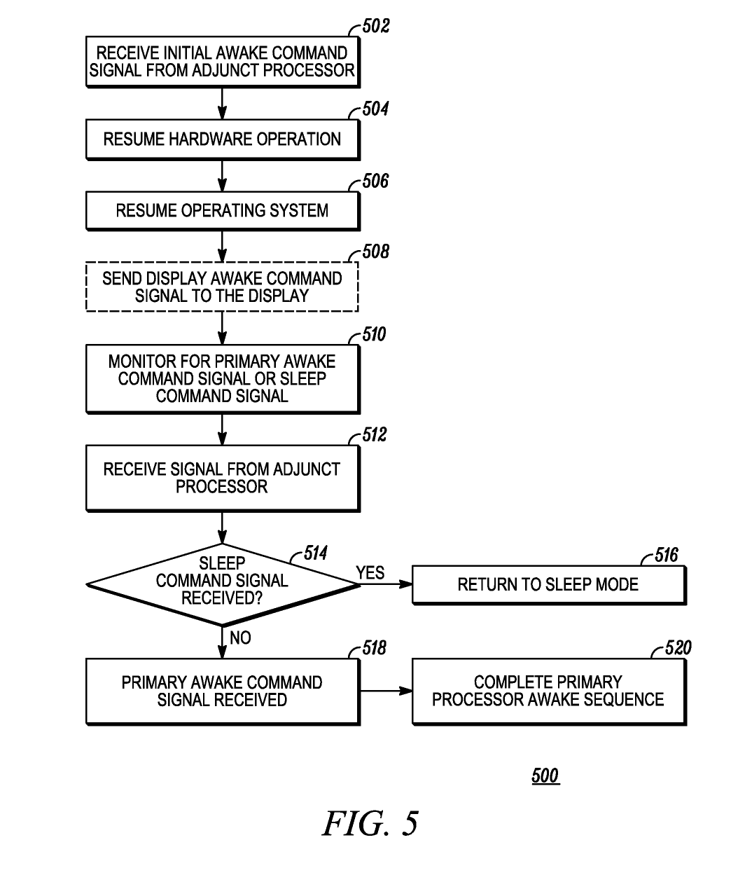

Turning now to FIG. 5, which illustrates a method 500 performed by a primary processor, e.g., 104, for exiting from a sleep mode in accordance with an embodiment of the present disclosure. Method 500 is performed where the adjunct processor is configured to send sleep command signals to the primary processor. Accordingly, the primary processor 104 receives 502 an initial awake command signal from the adjunct processor 102. The primary processor 104 resumes 504 hardware operation and resumes 506 an operating system. In one embodiment resuming 504 hardware operation includes turning on clocks, power supplies, and voltage regulators of the electronic device 100. Also, in one example scenario, resuming 506 the operating system includes at least partially booting a kernel of the device 100. In one embodiment, the primary processor awake sequence further includes sending 508 the display 108 a display awake command signal, and initializing display drivers.

The primary processor 104 monitors 510 for a primary awake command signal or a sleep command signal. When the primary processor 104 receives 512 a signal from the adjunct processor 102, the primary processor 104 determines 514 if the received signal is a sleep command signal. When the received signal is a sleep command signal, the primary processor 104 returns 516 to sleep mode. However, when the primary processor 104 receives 518 the primary awake command signal, the primary processor 104 completes 520 the primary processor awake sequence. In an embodiment, completing the primary processor awake sequence includes the primary processor 104 sending to the display 108 a display ON command signal to command the display 108 to complete the display awake sequence, for instance by lighting up the display.

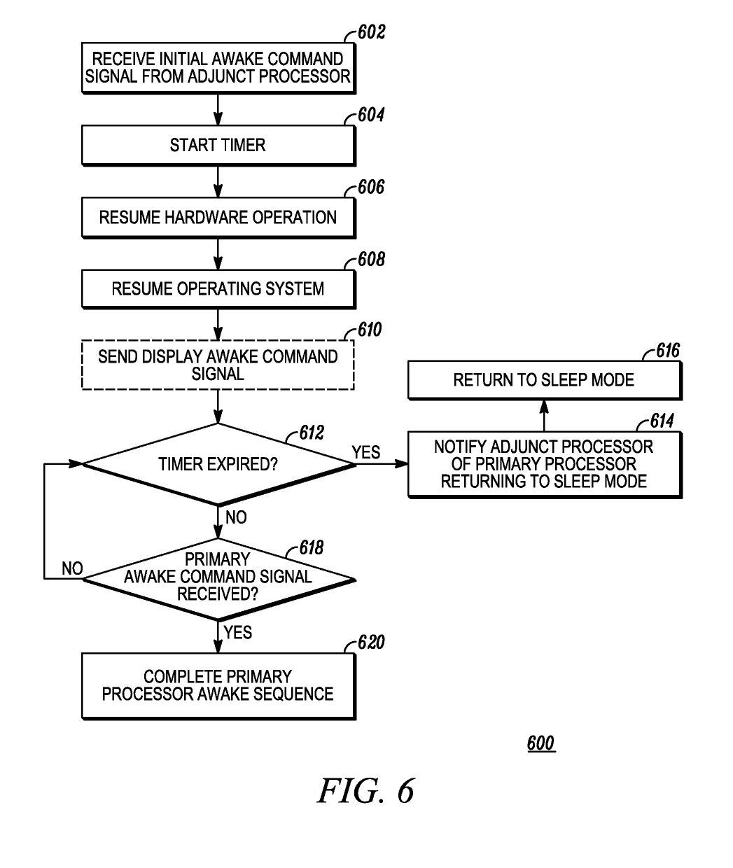

We now turn to FIG. 6, which illustrates a method 600 performed by a primary processor, e.g., 104, for exiting from a sleep mode in accordance with an embodiment of the present disclosure where the adjunct processor does not send sleep command signals to the primary processor. At 602, the primary processor 104 receives an initial awake command signal from the adjunct processor 102. The primary processor 104 immediately or substantially immediately, responsively, starts 604 a timer and initiates a primary processor awake sequence. The primary processor awake sequence includes resuming 606 hardware operation of the primary processor 104 and resuming 608 the operating system of the primary processor 104. As described above, the primary processor 104, in one embodiment, also sends 610 a display awake command signal to the display 108 as part of the primary processor awake sequence.

The primary processor 104 then monitors 618 for receipt of a primary awake command signal from the adjunct processor or another awakening component. If the timer expires 612 before receiving the primary awake command signal, the primary processor 104 notifies 614 the adjunct processor 102 of the primary processor 104 returning to sleep mode. The primary processor 104 then returns 616 to sleep mode. When the primary awake command signal is received 618 prior to the timer expiration, the primary processor 104 completes 620 the primary processor awake sequence.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The term “set” includes one or more. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., including a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter

We claim:

1. A method performed by an adjunct processor of a device for bringing a primary processor of the device out of a sleep mode, the method comprising:
monitoring a touchscreen of the device for a first continuous gesture;
sending, by the adjunct processor to the primary processor upon detecting the first continuous gesture, an initial awake command signal to awaken the primary processor from the sleep mode to initiate a primary processor awake sequence;
monitoring the touchscreen for completion of a second continuous gesture to initiate the sending, by the adjunct processor to the primary processor, of a primary awake command signal to indicate to the primary processor to complete the primary processor awake sequence.

2. The method of claim 1 further comprising upon detecting the completion of the second continuous gesture, sending the primary awake command signal to the primary processor.

3. The method of claim 1, wherein detecting the first continuous gesture comprises detecting a continuous contact along the touchscreen that extends a distance that exceeds a distance threshold.

4. The method of claim 3, wherein the distance is along a path traveled for the completion of the second continuous gesture.

5. The method of claim 1 further comprising, upon failing to detect the completion of the second continuous gesture, sending a sleep command signal to the primary processor to return the primary processor to the sleep mode.

6. The method of claim 5, wherein detecting the completion of the second gesture comprises detecting a contact with the touchscreen that starts in an initial region of the touchscreen and discontinues in a final region of the touchscreen, and failing to detect the completion of the second continuous gesture comprises detecting that the contact with the touchscreen discontinues outside of the final region.

7. The method of claim 1, wherein the first continuous gesture indicates a likelihood of receiving the second continuous gesture onto the touchscreen.

8. The method of claim 1, wherein detecting the first continuous gesture comprises detecting a continuous contact with the touchscreen that begins outside of a first region of the touchscreen and crosses into the first region of the touchscreen.

9. The method of claim 8, wherein the first region is delineated by at least one line of sensor elements that extends from a first side of the touchscreen to a second side of the touchscreen.

10. The method of claim 9, wherein the at least one line of sensor elements extends along an X-axis of the touchscreen.

11. The method of claim 9, wherein the at least one line of sensor elements extends along a Y-axis of the touchscreen.

12. The method of claim 8, wherein the first region is delineated by a set of sensor elements arranged in a geometric shape around an initial region of the touchscreen within which the continuous contact begins.

13. The method of claim 8, wherein the second continuous gesture is inclusive of the first continuous gesture, and wherein detecting the completion of the second continuous gesture comprises detecting that the continuous contact is maintained from the first region into a second region of the touchscreen.

14. The method of claim 13, wherein detecting the completion of the second continuous gesture comprises detecting that the continuous contact is discontinued in the second region of the touchscreen.

15. The method of claim 8, wherein detecting the first continuous gesture comprises detecting that the continuous contact begins in a central initial region on the touchscreen and crosses into the first region of the touchscreen.

16. An electronic device configured for bringing a primary processor out of a sleep mode, the electronic device comprising:
a touchscreen;
a primary processor configured to receive at least one of a primary awake command signal or an initial awake command signal and to responsively awaken from a sleep mode and initiate a primary processor awake sequence;
an adjunct processor coupled to the touchscreen and the primary processor and configured to:
monitor the touchscreen for a first continuous gesture and send the initial awake command signal to the primary processor upon detecting the first continuous gesture; and
monitor the touchscreen for completion of a second continuous gesture to initiate the sending of the primary awake command signal to indicate to the primary processor to complete the primary processor awake sequence.

17. The electronic device of claim 16, wherein the touchscreen comprises a plurality sensor elements for indicating contact to the touchscreen, wherein an initial region of the touchscreen is delineated by a first set of the plurality of sensor elements, a first region of the touchscreen is delineated by a second set of the plurality of sensor elements, and a second region of the touchscreen is delineated by a third set of the plurality of sensor elements.

18. The electronic device of claim 17, wherein the adjunct processor is configured to detect the first continuous gesture by detecting contact to the touchscreen across multiple sensor elements beginning at a first sensor element in the initial region and continuing to a second sensor element in the first region.

19. The electronic device of claim 17, wherein the adjunct processor is configured to detect completion of the second continuous gesture by detecting contact to the touchscreen across multiple sensor elements beginning at a first sensor element in the initial region and ending with a second sensor element in the second region.

20. The electronic device of claim 19, wherein the adjunct processor is further configured to:
send the primary awake command signal to the primary processor upon detecting the contact ending within the second region; or
send a sleep command signal to the primary processor to return the primary processor to the sleep mode upon detecting the contact ending outside of the second region.
